(19) United States
(12) Patent Application Publication
(10) Pub. No.: US 2014/0028545 A1
(43) Pub. Date: Jan. 30, 2014

(54) ELECTRONIC DEVICE WITH FUNCTION OF ADJUSTING DISPLAY RESOLUTION OR BRIGHTNESS AND METHOD

(71) Applicant: HON HAI PRECISION INDUSTRY CO., LTD., New Taipei (TW)

(72) Inventor: KUO-HSIUNG TSAI, New Taipei (TW)

(73) Assignee: HON HAI PRECISION INDUSTRY CO., LTD., New Taipei (TW)

(21) Appl. No.: 13/890,258

(22) Filed: May 9, 2013

(30) Foreign Application Priority Data
Jul. 27, 2012 (CN) 2012102639792

(51) Int. Cl. G06F 3/00

(52) U.S. Cl. CPC G06F 3/005
USPC 345/156

(57) ABSTRACT

An electronic device and a method for adjusting display resolution or brightness employed in a display are provided. The device includes a screen, a storage unit, a sensing unit, and a control unit. The storage unit stores a preset optimized distance and a first preset distance. The sensing unit senses a face of a user in the front of the device and a distance between the user and the device in real time. The control unit determines whether the distance becomes greater than the preset optimized distance, gradually decreases a resolution or brightness of the screen when the distance becomes greater than the preset optimized distance and is increasing, and gradually increases the resolution or brightness of the screen when the distance has reached the first preset distance and then decreases to become less than the first preset distance and keeps decreasing.

### BACKGROUND

1. Technical Field

The disclosure relates to electronic devices and, more particularly, to an electronic device capable of adjusting display resolution or brightness and a method for adjusting display resolution or brightness adapted for the electronic device.

2. Description of Related Art

In conventional electronic devices, such as televisions and computers, the display devices display programs with a high resolution or brightness at all times even the user leaves the electronic device, therefore wasting a lot of power. In addition, in order to save power, when the user leaves the electronic device, the user needs to decrease the resolution or brightness or turn off the electronic device manually, and when the user goes back to the electronic device, the user needs to increase the resolution or brightness or turn on the electronic device manually.

Therefore, what is needed is an electronic device to overcome the described shortcomings.

### BRIEF DESCRIPTION OF THE DRAWINGS

FIG. 1 is a block diagram of an electronic device, in accordance with an exemplary embodiment.

FIG. 2 is a block diagram of a control unit of the electronic device of FIG. 1.

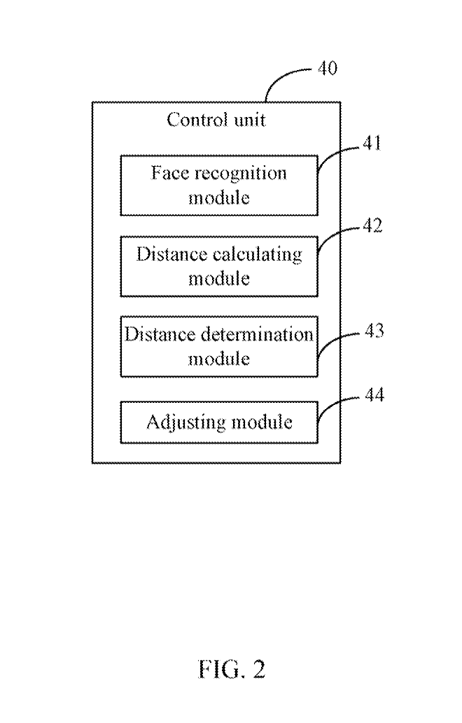

FIG. 3 is a flowchart of a method for adjusting display resolution or brightness employed by the electronic device of FIG. 1.

### DETAILED DESCRIPTION

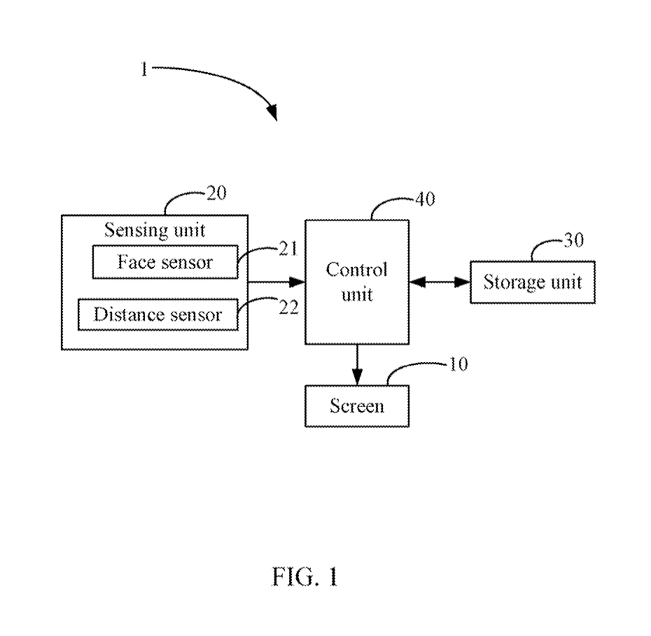

FIG. 1 is a block diagram of an electronic device, in accordance with an exemplary embodiment. The electronic device 1 may be a television, or a computer, etc. The electronic device 1 includes a screen 10, a sensing unit 20, a storage unit 30, and a control unit 40. The screen 10 displays information. The sensing unit 20 is to sense a user in the front of the electronic device 1. The sensing unit 20 includes a face sensor 21 and a distance sensor 22. In the embodiment, only one user is in the front of the electronic device 1. The face sensor 21 senses a face of the user of the electronic device 1 in real time. When the face sensor 21 senses the face of the user, the distance sensor 22 senses a distance between the user and the electronic device 1 in real time. The control unit 40 controls the electronic device 1.

The storage unit 30 stores a preset optimized distance between the user and the electronic device 1. At the preset optimized distance, the user can obtain a good viewing angle and thus to clearly view contents on the screen 10. The storage unit 30 further stores relationships between distances between the user and the electronic device 1 and resolution or brightness of the screen 10. In the embodiment, there are two relationships are illustrated, for example, a first preset distance corresponding to a first threshold value of the resolution or brightness of the screen 10, and a second preset distance corresponding to a second threshold value of the resolution or brightness of the screen 10.

The control unit 40 includes a face recognition module 41, a distance calculating module 42, a distance determination module 43, and an adjusting module 44.

The face recognition module 41 controls the face sensor 21 to sense the object in the front of the electronic device 1 in real time and recognizes whether a face of a user is in the front of the electronic device 1. For example, the face sensor 21 is a camera which captures an image in the front of the electronic device 1 and the face recognition module 41 recognizes whether the image includes facial features. When the face recognition module 41 recognizes that a face of a user is in the front of the electronic device 1, it is determined that the user is using the electronic device 1, for example, watching TV, the distance calculating module 42 controls the distance sensor 22 to calculate a distance between the user and the electronic device 1 in real time.

The distance determination module 43 determines whether the distance between the user and the electronic device 1 becomes greater than the preset optimized distance, it is determined that whether the user in the front of the electronic device 1 is being away from the electronic device 1 from the preset optimized distance. If the distance does not become greater than the preset optimized distance, it is determined that the user is near the preset optimized distance at all times, the adjusting module 44 maintains the current display resolution or brightness of the screen 10.

If the distance becomes greater than the preset optimized distance and is increasing, it is determined that the user is being away from the electronic device 1 from the preset optimized distance, the adjusting module 44 gradually decreases the resolution or brightness of the screen 10 and increases a contrast of the screen 10 and enlarges a display proportion of contents displayed on the screen 10. Therefore, when the user is away from the electronic device 1, the electronic device 1 saves power based on the decreased resolution or brightness of the screen 10 and the user can clearly look at the display contents based on the enlarged display proportion. In the embodiment, the adjusting module 44 gradually decreases the resolution or brightness of the screen 10 according to a preset percent.

Furthermore, when the distance determination module 43 determines that the distance increases to reach the first preset distance, it is determined that the user is very far from the electronic device 1 and does not want to look at the electronic device 1, the adjusting module 44 decreases the resolution or brightness of the screen 10 to the first threshold value. It is obvious that the first preset distance is greater than the preset optimized distance. Therefore, the electronic device 1 will save more power.

When the distance determination module 43 determines that the distance has reached the first preset distance and then decreases to become less than the first preset distance and keeps decreasing, it is determined that the user is gradually in proximity to the electronic device 1 and wants to look at the electronic device 1, the adjusting module 44 gradually increases the resolution or brightness of the screen 10. Therefore, when the user leaves the electronic device 1 and is in proximity to the electronic device 1, the electronic device 1 automatically adjusts the resolution or brightness of the screen 10. In the embodiment, the adjusting module 44 gradually increases the resolution or brightness of the screen 10 according to the preset percent.

When the distance determination module 43 determines that the distance decreases to reach the second preset distance, it is determined that the user is viewing the electronic device 1, the adjusting module 44 increases the resolution or brightness of the screen 10 to the second threshold value. The second preset distance is near to the preset optimized distance.

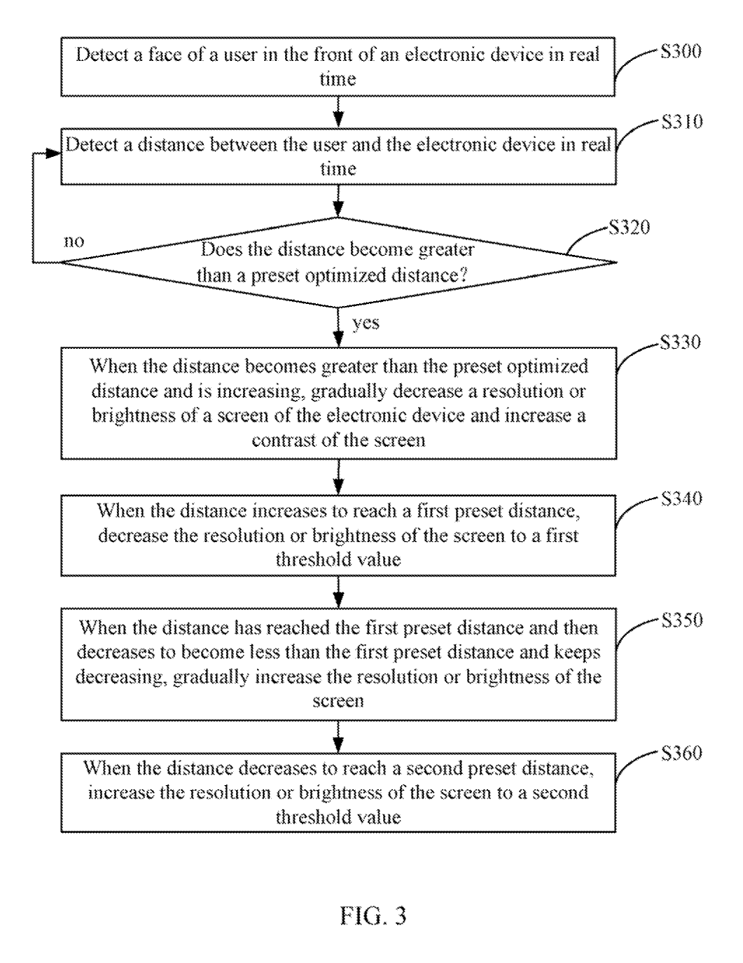

FIG. 3 is a flowchart of a method for adjusting display resolution or brightness employed by the electronic device of FIG. 1.

In step S300, the face recognition module 41 controls the face sensor 21 to detect a face of a user in the front of the electronic device 1 in real time.

In step S310, the distance calculating module 42 controls the distance sensor 22 to detect a distance between the user and the electronic device 1 in real time.

In step S320, the distance determination module 43 determines whether the distance becomes greater than the preset optimized distance. If the distance determination module 43 determines that the distance is inside the preset optimized distance at all times, the procedure returns to step S310, the adjusting module 44 maintains the current resolution or brightness of the screen 10 in accordance with the normal display mode.

In step S330, if the distance becomes greater than the preset optimized distance and is increasing, the adjusting module 44 gradually decreases the resolution or brightness of the screen 10 of the electronic device 1 and increases the contrast of the screen 10 and enlarges the display proportion of contents displayed on the screen 10.

In step S340, when the distance increases to reach the first preset distance, the adjusting module 44 decreases the resolution or brightness of the screen 10 to the first threshold value.

In step S350, when the distance has reached the first preset distance and then decreases to become less than the first preset distance and keeps decreasing, the adjusting module 44 gradually increases the resolution or brightness of the screen 10.

In step S360, when the distance decreases to reach the second preset distance, the adjusting module 44 increases the resolution or brightness of the screen 10 to the second threshold value.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a screen;
a storage unit to store a preset optimized distance and a first preset distance, wherein the first preset distance is greater than the preset optimized distance;
a sensing unit to sense a face of a user in the front of the electronic device and a distance between the user and the electronic device in real time; and
a control unit to determine whether the distance becomes greater than the preset optimized distance, gradually decrease a resolution or brightness of the screen when the distance becomes greater than the preset optimized distance and is increasing, and gradually increase the resolution or brightness of the screen when the distance has reached the first preset distance and then decreases to become less than the first preset distance and keeps decreasing.

2. The electronic device as recited in claim 1, wherein the sensing unit comprises a face sensor configured to sense the face of the user in real time and a distance sensor configured to sense a distance between the user and the electronic device in real time.

3. The electronic device as recited in claim 1, wherein the user can obtain a good viewing angle and can clearly view contents on the screen at the preset optimized distance.

4. The electronic device as recited in claim 1, wherein when the distance is inside the preset optimized distance at all times, the control unit is configured to maintain the current display resolution or brightness of the screen.

5. The electronic device as recited in claim 1, wherein when the distance becomes greater than the preset optimized distance and is increasing, the control unit is further configured to gradually increase a contrast of the screen and enlarge a display proportion of contents displayed on the screen.

6. The electronic device as recited in claim 1, wherein the control unit is configured to gradually decrease the resolution or brightness of the screen according to a preset percent.

7. The electronic device as recited in claim 1, wherein the storage unit is further configured to store a relationship that the first preset distance corresponding to a first threshold value of the resolution or brightness of the screen, when the distance increases to reach the first preset distance, the control unit is configured to decrease the resolution or brightness of the screen to the first threshold value.

8. The electronic device as recited in claim 1, wherein, the control unit is configured to gradually increase the resolution or brightness of the screen according to a preset percent

9. The electronic device as recited in claim 1, wherein the storage unit is further configured to store a relationship that a second preset distance corresponding to a second threshold value of the resolution or brightness of the screen, when the distance decreases to reach the second preset distance, the control unit is configured to increase the resolution or brightness of the screen to the second threshold value.

10. A method for adjusting display resolution or brightness for an electronic device, wherein the device comprises a screen, a sensing unit to sense a face of a user in the front of the electronic device and a distance between the user and the electronic device in real time, and the device stores a preset optimized distance and a first preset distance, the first preset distance is greater than the preset optimized distance, the method comprising:
determining whether the distance between the user and the electronic device becomes greater than the preset optimized distance;
when the distance becomes greater than the preset optimized distance and is increasing, gradually decreasing a resolution or brightness of the screen; and
when the distance has reached the first preset distance and then decreases to become less than the first preset distance and keeps decreasing, gradually increasing the resolution or brightness of the screen.

11. The method as recited in claim 10, wherein the user can obtain a good viewing angle and can clearly view contents on the screen at the preset optimized distance.

12. The method as recited in claim 10, further comprising:
when the distance is inside the preset optimized distance at all times, maintaining the current display resolution or brightness of the screen.

13. The method as recited in claim 10, further comprising:
when the distance becomes greater than the preset optimized distance and is increasing, gradually increasing a contrast of the screen and enlarging a display proportion of contents displayed on the screen.

14. The method as recited in claim 10, the step “gradually decreasing a resolution or brightness of the screen” comprising:
gradually decreasing the resolution or brightness of the screen according to a preset percent.

15. The method as recited in claim 10, wherein the electronic device stores a relationship that the first preset distance corresponding to a first threshold value of the resolution or brightness of the screen, the method further comprising:
when the distance increases to reach the first preset distance, decreasing the resolution or brightness of the screen to the first threshold value.

16. The method as recited in claim 10, the step “gradually increasing a resolution or brightness of the screen” comprising:
gradually increasing the resolution or brightness of the screen according to a preset percent.

17. The method as recited in claim 10, wherein the electronic device stores a relationship that a second preset distance corresponding to a second threshold value of the resolution or brightness of the screen, the method comprising:
when the distance decreases to reach the second preset distance, increasing the resolution or brightness of the screen to the second threshold value.
